(19) United States
(12) Patent Application Publication
(10) Pub. No.: US 2003/0002213 A1
(43) Pub. Date: Jan. 2, 2003

(54) Glass epoxy board and magnetic head device

(76) Inventor: Tomohiko Ohsaka, Yamagata-shi (JP)

Correspondence Address: LADAS & PARRY, 224 SOUTH MICHIGAN AVENUE, SUITE 1200, CHICAGO, IL, 60604, US

(21) Appl. No.: 10/182,004

(22) PCT Filed: Nov. 30, 2001
(86) PCT No.: PCT/JP01/10511

(30) Foreign Application Priority Data
Feb. 1, 2001 (JP) 2001-025504

(51) Int. Cl. G11B 5/127

(52) U.S. Cl. 360/128

(57) ABSTRACT

The present invention relates to a glass epoxy substrate used as a substrate or a reinforcement board in a variety of electric circuits, and to a magnetic head device including such a glass epoxy substrate. The glass epoxy substrate is formed by holding a glass cloth inside an epoxy resin layer containing carbon powder. Thereby, the glass epoxy substrate is ensured appropriate conductivity by the carbon powder. Therefore, the charging of the glass epoxy substrate can be prevented and the generation of static electricity therein can be controlled.

### TECHNICAL FIELD

The present invention relates to a glass epoxy substrate used as a substrate or a reinforcement board for a variety of electric circuits, and also to a magnetic head device including such a glass epoxy substrate.

### BACKGROUND ART

Conventionally, a magnetic head device that causes a magnetic signal corresponding to an information signal to be recorded on or reproduced from a magnetic recording medium such as a magnetic tape by a magnetic head has been widely used. The magnetic head device has the magnetic head provided at a position opposing the surface of the magnetic tape on which surface a signal is recorded. The magnetic head and a circuit board provided to the main body of the device are electrically connected by, for instance, a flexible print circuit (FPC). The FPC is provided with electric interconnection lines and has flexibility. Therefore, a reinforcement board is used at the connection of the FPC and the circuit board so as to ensure sufficient electrical connection.

Generally, a glass epoxy substrate is widely used as the reinforcement board. As shown in FIGS. 1 and 2, the glass epoxy substrate, which is structured to hold glass cloths 100 woven like a lattice inside an epoxy resin layer 101, has a substantially flat-plate shape. The glass epoxy substrate not only has sufficient electrical insulation, but also contains the glass cloths 100 inside, thus having sufficient mechanical strength.

A magnetic head device is required to perform recording and reproduction on a magnetic tape with high recording density so as to be smaller in size with increased capacity. Therefore, in order to detect a magnetic signal recorded on a magnetic tape with high accuracy, a magnetic head device has been proposed that has a magnetic head to which a magnetoresistive element (hereinafter referred to as an MR element) is provided as a magneto-sensitive element. The MR element, which is formed by layering a plurality of conductive layers with an extremely thin insulation layer being interposed therebetween, is thus vulnerable to static electricity.

On the other hand, conventionally, insulating properties have been considered important with respect to the glass epoxy substrate used for the connection part of the FPC electrically connecting the magnetic head and the circuit board provided to the device main body as described above. Therefore, the electrical resistances of its surface range approximately from 10¹⁰Ω to 10¹²Ω. Further, since an epoxy resin shows a good characteristic as a dielectric, there has been a problem in that the glass epoxy substrate is apt to be charged so as to generate high static electricity by friction.

Accordingly, in the case of employing the MR element in the magnetic head, there has been a problem in that electrostatic discharge is caused in the MR element of the magnetic head at the time of its assembly by static electricity generated in the glass epoxy substrate in the connection part of the FPC.

### DISCLOSURE OF THE INVENTION

A general object of the present invention is to provide in which the above-described disadvantages are eliminated.

A more specific object of the present invention is to provide a glass epoxy substrate that is prevented from being charged and in which the generation of static electricity is controlled.

Another object of the present invention is to provide a magnetic head device preventing electrostatic discharge from occurring in the magnetoresistive element of its magnetic head.

In order to achieve the above objects, a glass epoxy substrate according to the present invention is characterized by being configured to hold a glass cloth inside a glass epoxy layer containing carbon powder.

According to the present invention, the glass epoxy substrate according to the present invention is ensured appropriate conductivity by the carbon powder. Therefore, the charging of the glass epoxy substrate can be prevented and the generation of static electricity can be controlled.

Additionally, an electrical resistance of a surface of the glass epoxy substrate according to the present invention is preferably larger than or equal to 10⁵Ω and smaller than or equal to 10¹⁰Ω.

Thereby, the glass epoxy substrate shows appropriate conductivity so that the generation of static electricity can be controlled reliably and sufficiently.

Further, in order to achieve the above objects, a magnetic head device according to the present invention includes a magnetic head detecting, by a magnetoresistive element, a magnetic signal recorded on a magnetic recording medium, and is characterized by including a glass epoxy substrate as a reinforcement board used for a flexible print circuit electrically connecting the magnetic head and a circuit board, the glass epoxy substrate holding a glass cloth inside an epoxy resin layer containing carbon powder.

Thereby, in the magnetic head device according to the present invention, the glass epoxy substrate shows appropriate conductivity by including the carbon powder, so that the charging of the glass epoxy substrate can be prevented and the generation of static electricity therein can be controlled. Accordingly, electrostatic discharge can be prevented from occurring in the magnetoresistive element of the magnetic head.

Additionally, in the magnetic head device according to the present invention, an electrical resistance of a surface of the glass epoxy substrate is preferably larger than or equal to 10⁵Ω and smaller than or equal to 10¹⁰Ω.

Thereby, the glass epoxy substrate shows appropriate conductivity by including the carbon powder, and the generation of static electricity therein can be controlled reliably and sufficiently so as to reliably prevent electrostatic discharge from occurring in the magnetoresistive element.

### BRIEF DESCRIPTION OF THE DRAWINGS

Other objects, features and advantages of the present invention will become more apparent from the following detailed description when read in conjunction with the accompanying drawings, in which:

FIG. 1 is a schematic perspective view of a conventional glass epoxy substrate;

FIG. 2 is a schematic sectional view of the conventional glass epoxy substrate;

FIG. 3 is a schematic perspective view of an important part of a magnetic head device to which the present invention is applied; and

FIG. 4 is a schematic sectional view of a glass epoxy substrate provided to the magnetic head device.

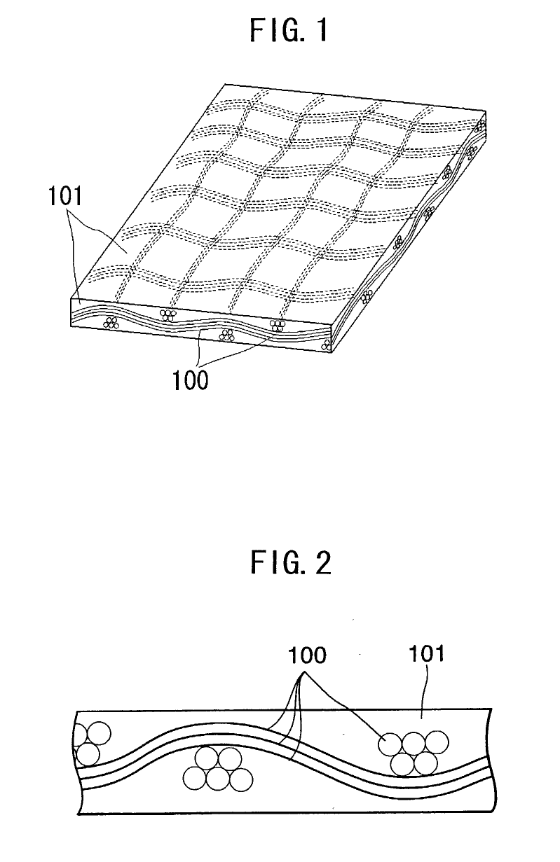

### BEST MODE FOR CARRYING OUT THE INVENTION

A description will now be given, with reference to the drawings, of an embodiment of the present invention.

In the following, a case in which the present invention is applied to a magnetic head device will be described.

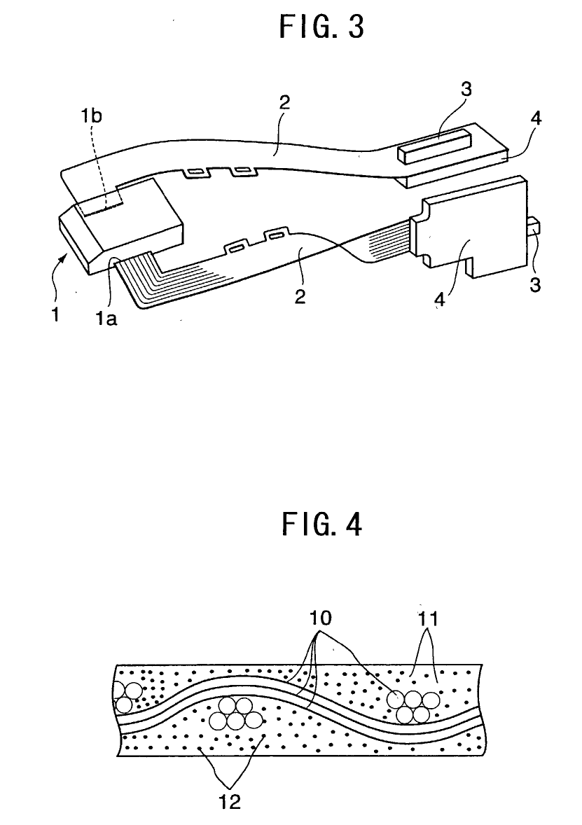

As shown in FIG. 3, the magnetic head device includes a magnetic head 1, which is provided at a position opposing the surface of a magnetic tape on which surface a signal is recorded. A magnetoresistive element (MR element) is provided to the magnetic head 1 as a magneto-sensitive element detecting a magnetic signal recorded on the magnetic tape.

The MR element, which is a magneto-sensitive element using the magnetoresistive effect, is formed to have its resistance varying with a change in external magnetic fields. In the magnetic head device, the magnetic signal recorded on the magnetic tape is reproduced by supplying a sense current to the MR element of the magnetic head 1 and detecting a change in the resistance of the MR element as a change in voltage.

Further, in the magnetic head device, a control part controlling the operation of the entire device and a signal processing part performing a variety of operations on an information signal to be recorded on or reproduced from the magnetic tape are realized by a variety of semiconductor devices and integrated circuits and provided on a circuit board (not shown in FIG. 3).

Further, the magnetic head device includes a drive mechanism for having the magnetic tape run in a position opposing the magnetic head 1 and a detachment mechanism allowing the magnetic tape to be freely detached from and attached to the main body of the device. Since these mechanisms may have the same structures as in the widely used conventional magnetic head device, their graphical representation in FIG. 3 and their detailed description in the following will be omitted.

In the magnetic head device, as shown in FIG. 3, the magnetic head 1 has each of terminal parts 1a and 1b thereof connected to one end of a corresponding flexible print circuit (FPC) 2 formed by forming a thin-film electrode pattern on a flexible film substrate.

A terminal part 3 for electrical connection with the circuit board provided to the main body of the magnetic head device is provided to the other end of each of the paired FPCs 2. The terminal parts 1a and 1b of the magnetic head 1 are electrically connected with the circuit board provided to the main body of the magnetic head device via the FPCs 2 and the terminal parts 3.

At the end of each FPC 2 to which end the terminal part 3 is provided, a glass epoxy substrate 4 is provided on the side opposite to the terminal part 3 side for reinforcing mechanical strength in the connection part of the FPC 2.

As shown in FIG. 4, the glass epoxy substrate 4 is structured so that a plurality of glass cloths 10 each woven from a glass material like a lattice are held inside an epoxy resin layer 11 formed of a hardened epoxy resin. Further, the glass epoxy substrate 4 includes carbon powder 12 in the epoxy resin layer 11 so as to show conductivity to an appropriate degree.

The glass epoxy substrate 4 having the above-described configuration is structured so that the glass cloths 10 are held inside the epoxy resin layer 11. Therefore, the glass epoxy substrate 4 has a high mechanical strength so as to be capable of securing good connection between each FPC 2 and the circuit board.

Further, the glass epoxy substrate 4 shows appropriate conductivity by including the carbon powder 12 in the epoxy resin layer 11. Therefore, the charging of the glass epoxy substrate 4 can be prevented and the generation of static electricity therein can be reduced significantly.

Thereby, the magnetic head device having the above-described glass epoxy substrates 4 can be ensured good and reliable connection with the circuit board provided to the main body of the device in the terminal parts 3 of the FPCs 2, and can significantly reduce the generation of static electricity in the connection parts.

Accordingly, in the magnetic head device to which the present invention is applied, static electricity is prevented from being generated in the parts conducting to the terminal parts 1a and 1b of the magnetic head 1 at the time of assembling the device. Further, even in the case of including an MR element in the magnetic head 1 as a magneto-sensitive element, the MR element is prevented from being damaged by static electricity.

In the glass epoxy substrate 4, the materials and structures of the glass cloths 10 and the epoxy resin layer 11 are not limited in particular, but the same materials and structures as employed in the conventional glass epoxy substrate may be used. Thereby, the same mechanical strength as that of the conventional glass epoxy substrate can be ensured.

Further, the electrical resistance of the surface of the glass epoxy substrate 4 is preferably larger than or equal to 10⁵Ω and smaller than or equal to 10¹⁰Ω. If the electrical resistance is smaller than 10⁵Ω, it is difficult to ensure that the glass epoxy substrate 4 has sufficient insulating properties, so that the connections of the FPCs 2 with the circuit board have poor insulation. Further, if the electrical resistance exceeds 10¹⁰Ω, it is impossible to ensure that the glass epoxy substrate 4 has sufficient conductivity and the glass epoxy substrate 4 is apt to become charged, so that it is difficult to sufficiently control the generation of static electricity.

The electrical resistance of the glass epoxy substrate 4 can be controlled by the amount of the carbon powder 12 contained in the epoxy resin layer 11.

As described above, the glass epoxy substrate 4 according to the present invention is ensured appropriate conductivity by the carbon powder 12. Therefore, the charging of the glass epoxy substrate 4 can be avoided and the generation of static electricity therein can be controlled.

Accordingly, the glass epoxy substrate 4 according to the present invention can be used as a reinforcement board for a circuit board in a wide variety of devices including elements and parts vulnerable to static electricity, such as magnetic heads using MR elements. Thereby, a simple and reliable measure against static electricity can be realized.

Further, the magnetic head device according to the present invention, which shows appropriate conductivity by containing the carbon powder 12 in the glass epoxy substrate 4, prevents the charging of the glass epoxy substrate 4, thus controlling the generation of static electricity.

Thereby, electrostatic discharge is prevented from occurring in the MR element of the magnetic head 1. Therefore, according to the present invention, the yield rate at the time of assembling the magnetic head device can be increased, so that the magnetic head device including a highly reliable magnetic head can be realized at low cost.

The present invention is not limited to the specifically disclosed embodiment, but variations and modifications may be made without departing from the claimed scope of the present invention.

1. A glass epoxy substrate characterized by holding a glass cloth inside a glass epoxy layer containing carbon powder.

2. The glass epoxy substrate as claimed in claim 1, characterized in that an electrical resistance of a surface of the glass epoxy substrate is larger than or equal to 10⁵Ω and smaller than or equal to 10¹⁰106 .

3. A magnetic head device including a magnetic head detecting, by a magnetoresistive element, a magnetic signal recorded on a magnetic recording medium, characterized by comprising:
a glass epoxy substrate as a reinforcement board used for a flexible print circuit electrically connecting the magnetic head and a circuit board, the glass epoxy substrate holding a glass cloth inside an epoxy resin layer containing carbon powder.

4. The magnetic head device as claimed in claim 3, wherein an electrical resistance of a surface of said glass epoxy substrate is larger than or equal to 10⁵Ω and smaller than or equal to 10¹⁰Ω.
